(19) United States
(12) Patent Application Publication
(10) Pub. No.: US 2009/0290825 A1
(43) Pub. Date: Nov. 26, 2009

(54) ROLLER BEARING BALL, ROLLER BEARING, AND METHOD FOR TREATING ROLLER BEARING BALLS

(75) Inventors: Rainer Eidloth, Herzogenaurach (DE); Peter Schuster, Fuerth (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/447,129

(22) PCT Filed: Oct. 23, 2007
(86) PCT No.: PCT/DE2007/001901

§ 371 Date: Jul. 2, 2009

(30) Foreign Application Priority Data
Oct. 26, 2006 (DE) 10 2006 050 445.3

(51) Int. Cl. F16C 19/04; B32B 3/00; B01J 19/08; F16C 33/36

(52) U.S. Cl. 384/490; 428/403; 427/598; 384/491

(57) ABSTRACT

In order to provide a roller bearing ball, a roller bearing and a method for treating roller bearing balls, which are distinguished by an inexpensive and, in terms of production technology, simple surface treatment or coating of the rolling bodies, there is provision for the spherical rolling face of the roller bearing ball which rolls on a running face of a roller bearing in operation to have at least one flattened portion.

### FIELD OF THE INVENTION

The invention lies in the field of ball bearings, in particular for use in dry or medium lubrication under lubricating conditions which are from suboptimum to poor.

The invention relates to a roller bearing ball having a spherical rolling face which rolls during operation on a running face of a roller bearing. Furthermore, the invention relates to a roller bearing having a plurality of roller bearing balls and having a roller bearing ring with a running face, on which rolling faces of the roller bearing balls roll during operation. Finally, the invention relates to a method for treating roller bearing balls.

Ever higher requirements with regard to the service life and wear resistance are made of ball bearings, in particular high performance bearings, under increasing cost pressure. In this context, EP 0 807 761 B1 has disclosed a roller bearing ball and a roller bearing of the type which is mentioned in the introduction, EP 0 807 761 B1 being directed at the problem that slight dents and elevations, in particular on the raceway of the bearing rings, can be produced with increasing running life and dirt particles which penetrate into the bearing. Said dents and elevations can lead to increased bearing noise and a shortened service life. In order to solve this problem, it is proposed to provide at least one rolling body with a hardened surface encapsulation which is harder and more rigid than the material of the other rolling bodies.

In order to improve the bearing properties, roller bearings having improved solid lubrication are known (DE 199 81 108 T1) or special, wear-resistant sintered rolling bodies, for example by hot pressing, have been disclosed (EP 0 158 901 B1).

In practice, it has been shown (cf. EP 0 691 483 B1) that the examination of treated rolling bodies is comparatively complicated, in particular if rolling bodies having a spherical surface (that is to say, bearing balls) are used. For the treatment of bearing balls of this type, for example, by means of coating by way of coating processes which are known per se, such as PVD, CVD, spray coatings or PA-CVD and lacquering, the problem arises of treating the bearing balls reliably and uniformly, which bearing balls are comparatively difficult to handle. Along with the expenditure of the treatment, the manufacturing expenditure of corresponding roller bearings and therefore ultimately the manufacturing costs also naturally rise.

Against this background, it is an object of the present invention to provide a roller bearing ball, a roller bearing and a method for treating roller bearing balls, which are distinguished by a surface treatment or coating of the rolling bodies which is inexpensive and simple in terms of manufacturing technology.

According to the invention, this object is achieved in a rolling ball of the type which is mentioned in the introduction by virtue of the fact that the roller bearing ball has at least one flattened portion. A receptacle or holding apparatus can act comparatively simply on this flattened portion for handling the roller bearing ball and for transporting it in a manner which accompanies the manufacturing process. Here, a single flattened portion can be provided on the roller bearing ball or can be provided by the removal of material, on which flattened portion a holding apparatus can act reliably and sufficiently fixedly.

One essential aspect of the present invention therefore comprises the fact that it departs from the traditional rolling body design which aims at an optimum spherical shape and consciously accepts an unbalance (which is tolerable and small, however) and a reduction in the surface area of the rolling body which is available for loadbearing rolling. However, this surprisingly scarcely influences the running properties of the rolling body, but permits considerably improved handling

One advantageous refinement of the invention which is particularly stable, symmetrical and manages with particularly small flatted faces provides for the roller bearing ball to have two flattened portions which lie diametrically opposite one another.

According to one advantageous refinement of the invention, receiving depressions which preferably lie symmetrically opposite one another can be provided in the flattened portions.

Corresponding elements of a holding apparatus can engage into said receiving depressions, with the result that the roller bearing ball is held particularly reliably

A roller bearing according to the invention advantageously provides a plurality of roller bearing balls which have at least one flattened portion each, and has at least one roller bearing ring with a running face, on which the rolling faces of the roller bearing balls roll during operation.

The method according to the invention for treating roller bearing balls provides for the roller bearing ball to be provided with at least one flattened portion, and for the roller bearing ball to be held on the flattened portion by the holding apparatus. Here, the holding apparatus can preferably engage into the above-mentioned receiving depressions which have previously been produced starting from the flattened portion.

As an alternative or in addition, according to one advantageous embodiment of the method according to the invention, the roller bearing ball can be held by the holding apparatus as a result of magnetic forces.

In an additional or complementary manner, further advantages and aspects of the invention result from the following description of the invention with reference to the drawing, in which:

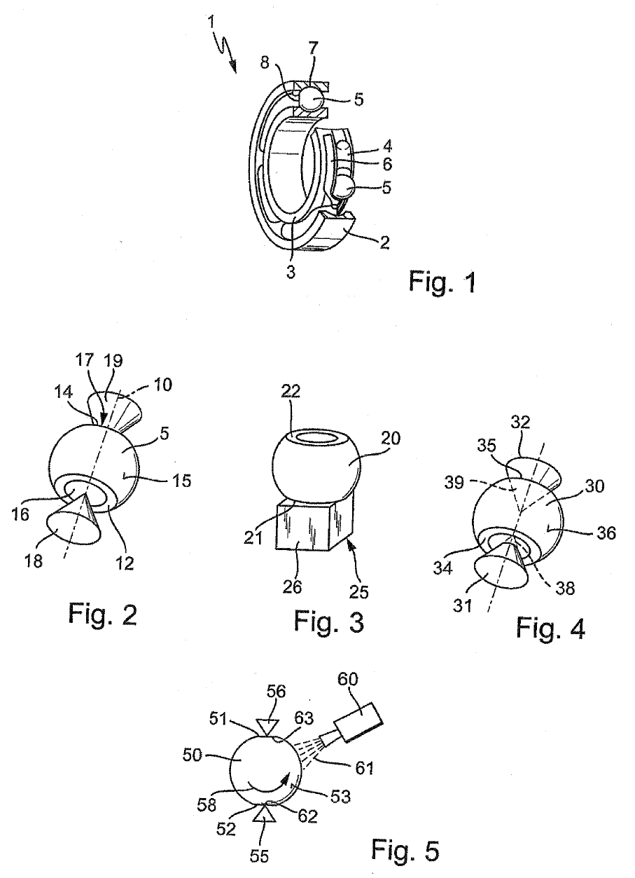

FIG. 1 shows a roller bearing according to the invention;

FIG. 2 shows a roller bearing ball in a first holding apparatus;

FIG. 3 shows a roller bearing ball in a second holding apparatus;

FIG. 4 shows a roller bearing ball in a third holding apparatus; and

FIG. 5 schematically shows operations in the method according to the invention for treating roller bearing balls.

FIG. 1 shows a roller bearing 1 having an outer bearing ring 2, an inner bearing ring 3 and a cage 4 which is arranged between the bearing rings and in which a multiplicity of bearing balls 5 are held in a spaced-apart manner by spacer elements 6. As can be seen schematically on the upper ball 5, its ball surface 7 has a flattened portion 8.

FIG. 2 shows a single roller bearing ball 5 in isolation during the manufacturing. The ball 5 has a main axis of symmetry 10, at the respective end of which, and therefore lying diametrically opposite one another, flattened portions 12, 14 are provided in the ball surface 15. Here, the flattened portions 12, 14 are shown with their dimensions greatly exaggerated only for reasons of clarity. It can be seen that the flattened portions are substantially planar and engagement faces (only the engagement face 16 can be seen) are provided for cone tips 18, 19 of a holding apparatus (not shown in greater detail). The cone tips 18, 19 press onto the engagement faces 16, 17, center and therefore hold said ball 5 in a position which is suitable for further surface processing.

FIG. 3 shows an alternative holding apparatus, in which a roller bearing ball 20 likewise has flattened portions 21, 22. It can be expedient for reasons of symmetry to provide two flattened portions 21, 22, although a single flattened portion would be sufficient for the holding apparatus 25. According to FIG. 3, the holding apparatus namely comprises a magnetic or magnetizable holding body 26 which fixes the ball 20 which is composed at least partially of magnetic material. The advantage of this refinement is even simpler fixing of the ball 20 even if a greater region of the flattened portion 21 is covered as a result. However, since this region is not pressure loaded for active load transfer during operation of the roller bearing, an incomplete surface treatment in the region of the flattened portion 21 can be accepted for certain applications.

FIG. 4 shows an alternative, in which a roller bearing ball 30 is held in turn between two cones 31, 32. They can be configured as a truncated cone and therefore rest flatly on a flattened portion 34, 35 on the ball surface 36 or else penetrate with their tip into depressions or recesses 38, 39 and, as a result, ensure a particularly fixed grip of the ball 30.

In accordance with the method according to the invention, as illustrated schematically by FIG. 5, a roller bearing ball 50 is held at its flattened portions 51, 52, which, in the orientation according to FIG. 5, are produced in the region of its poles, on the ball surface 53 by tool tips 55, 56 of a holding apparatus 57. As indicated by the arrow 58, the ball 50 can be set in rotation, with the result that coating material 61 which is dispensed by a coating device 60 is distributed uniformly on the ball surface 53. Here too, the tool tips 55, 56 can engage into receiving depressions which are not shown explicitly in FIG. 5. As an alternative, the tool tips 55, 56 can also be configured as a truncated cone, with the result that they come into contact with the respective flattened portion by way of the upper truncated cone face.

By way of the refinement according to the invention of the roller bearing balls or by way of the roller bearing according to the invention and the method according to the invention for treating roller bearing balls, an amazingly effective possibility is provided with extremely simple means to treat the roller bearing ball in the production process in a time-saving and therefore inexpensive manner, which has a positive effect on the overall costs of the roller bearing. The handling and the holding or fixing of the roller bearing ball in the production process can be automated particularly simply as a result of its shape.

### LIST OF DESIGNATIONS

1 Roller bearing
2 Outer bearing ring
3 Inner bearing ring
4 Cage
5 Bearing ball
6 Spacer element
7 Ball surface
8 Flattened portion
10 Main axis of symmetry
12, 14 Flattened portions
15 Ball surface
16, 17 Engagement faces
18, 19 Cone tips
20 Roller bearing ball
21, 22 Flattened portions
25 Holding apparatus
26 Magnetic or magnetizable holding body
30 Roller bearing ball
31, 32 Cone
34, 35 Flattened portions
36 Ball surface
38, 39 Depressions or recesses
50 Roller bearing ball
51, 52 Flattened portions
53 Ball surface
55, 56 Tool tips
57 Holding apparatus
58 Arrow
60 Coating device
61 Coating material

1. A roller bearing ball having a spherical rolling face which rolls during operation on a running face of a roller bearing, wherein the roller bearing ball has at least one flattened portion.

2. The roller bearing as claimed in claim 1, wherein the roller bearing ball has two flattened portions which lie diametrically opposite one another.

3. The roller bearing ball as claimed in claim 2, wherein flattened portions have receiving depressions.

4. The roller bearing ball as claimed in claim 3, wherein at least one of the flattened portions is of planar configuration and encloses a receiving depression, into which tips of cones can be inserted.

5. The roller bearing ball as claimed in claim 2, wherein the at least one flattened portion is substantially planar, and provides an engagement face for a cone tip.

6. The roller bearing ball as claimed in claim 1, wherein the ball is composed at least partially of a magnetic material.

7. A roller bearing having a plurality of roller bearing balls and having at least one roller bearing ring with a running face, on which, rolling faces of the roller bearing balls roll during operation, wherein the roller bearing balls have, in each case, at least one flattened portion.

8. A method for carrying out a surface treatment of a roller bearing ball as claimed in claim 1, in which method the roller bearing ball is provided with at least one flattened portion and the roller bearing ball is held on the flattened portion by a holding apparatus, the roller bearing ball being held is set in rotation, and the surface treatment comprising a uniform application of a coating material onto a surface of the roller bearing ball being held.

9. The method as claimed in claim 8, in which the roller bearing ball is held by engagement of the holding apparatus in receiving depressions which have previously been produced starting from the flattened portion.

10. The method as claimed in claim 8, in which the roller bearing ball is held by the holding apparatus as a result of magnetic forces, and in that, the roller bearing ball is composed at least partially of a magnetic material.
